(19) United States
(12) Patent Application Publication
(10) Pub. No.: US 2025/0390900 A1
(43) Pub. Date: Dec. 25, 2025

(54) COMMERCIAL ACTIVITY SUPPORT SYSTEM

(71) Applicant: TOYOTA JIDOSHA KABUSHIKI KAISHA, Aichi-ken (JP)

(72) Inventors: Hiroki SATO, Chuo-ku (JP); Shogo NOGUCHI, Suginami-ku (JP); Maika HASHIMOTO, Urayasu-shi (JP); Norichika TOGAWA, Shinagawa-ku (JP)

(21) Appl. No.: 19/231,555

(22) Filed: Jun. 9, 2025

(30) Foreign Application Priority Data
Jun. 25, 2024 (JP) 2024-102066

(51) Int. Cl. G06Q 30/0203; G06Q 30/0202

(52) U.S. Cl. CPC G06Q 30/0203; G06Q 30/0202; G06Q 2230/00

(57) ABSTRACT

One or more processors of a system that supports a commercial activity of a store execute processing to generate voting proposal information for making multiple candidates for at least one of a new product and a new service voting targets for request voting by customers of the store. The one or more processors also execute processing to send the voting proposal information to a voting reception terminal and processing to receive voting response information from the voting reception terminal in response to the voting proposal information.

The present application claims priority under 35 U.S.C. § 119 to Japanese Patent Application No. 2024-102066, filed on Jun. 25, 2024, the contents of which application are incorporated herein by reference in their entirety.

### TECHNICAL FIELD

The present disclosure relates to a system that supports commercial activity of a store that performs at least one of product sales and service provision.

### BACKGROUND

JP2008065488A discloses an equipment that suggests ordering a number of a product to a store to be sold at the store. The equipment of the related art collects information on an out-of-stock product (i.e., a product that customers could not purchase due to out-of-stock) through surveys of customers who purchased products in the store, and calculates shortage number of the out-of-stock product. The equipment of the related art also calculates the number of the out-of-stock product to be ordered by the store based on the store's product ordering history information. Furthermore, the equipment of the related art calculates recommended order number of the out-of-stock product based on the number of the out-of-stock product to be ordered and the shortage number of the out-of-stock product, and proposes it to the store.

Examples of the documents showing the technical level in the technical field related to the present disclosure include JP2007102481A and JP2023092350A in addition to JP2008065488A.

Consideration is given to supporting a commercial activity of a store that perform at least one of product sales and service provision. Examples of this support include grasping customer needs for products sold by the store or services provided by the store.

According to the equipment of the related art, the store can grasp from the survey results customer needs for the products. However, object products of the survey are limited to those currently sold in the store or those that customers are aware of being sold in the store. Therefore, it is not possible to grasp customer needs for products that have no sales record in the store or for products that the customers are unaware of. Therefore, technology development is desired to grasp customer needs for new product sales or new service provision for the store or the store's customers.

One of the objectives of the present disclosure is to provide technology that allows the store to grasp customer needs for a product the store is considering selling or a service the store is considering providing.

### SUMMARY

The present disclosure is a commercial activity support system for supporting a commercial activity of a store that performs at least one of product sales and service provision and has the following features.

The system comprises one or more memory devices and one or more processors. The one or more memory devices store store information related to the store. The one or more processors are configured to execute various processing. The store information includes information on at least one of a new product that the store is considering selling and information on a new service that the store is considering providing.

The one or more processors are configured to execute processing to: generate voting proposal information for making multiple candidates for at least one of the new product and the new service with respect to voting targets for request voting by customers of the store, based on information on at least one of the new product and the new service, and send this information to a voting reception terminal; and receive voting response information from the voting reception terminal in response to the voting proposal information.

According to the commercial activity support system, it is possible to propose participation in the request voting using the voting reception terminal to the customers of the store and collect the voting result information having multiple candidates for at least one of the new product the store is considering selling and the new service the store is considering offering as the voting targets. Therefore, it is possible to grasp customer needs regarding the new product and the new service.

### BRIEF DESCRIPTION OF THE DRAWINGS

FIG. 1 is a diagram for illustrating a configuration example of a commercial activity support system according to an embodiment of the present disclosure;

FIG. 2 is a diagram illustrating an example of various information used in request voting processing;

FIG. 3 is a flowchart illustrating an example of request voting processing;

FIG. 4 is a flowchart illustrating an example of the request voting processing;

FIG. 5 is a diagram showing an example of information output from a voting reception terminal during processing steps S21 to S24 in FIG. 4;

FIG. 6 is a flowchart illustrating an example of the request voting processing; and

FIG. 7 is a flowchart illustrating an example of the request voting processing.

### DESCRIPTION OF EMBODIMENT

Hereinafter, an embodiment of the present disclosure will be described with reference to the drawings. In the drawings, the same or corresponding parts are denoted by the same reference numerals, and the description thereof will be simplified or omitted.

### 1. Configuration Example of System

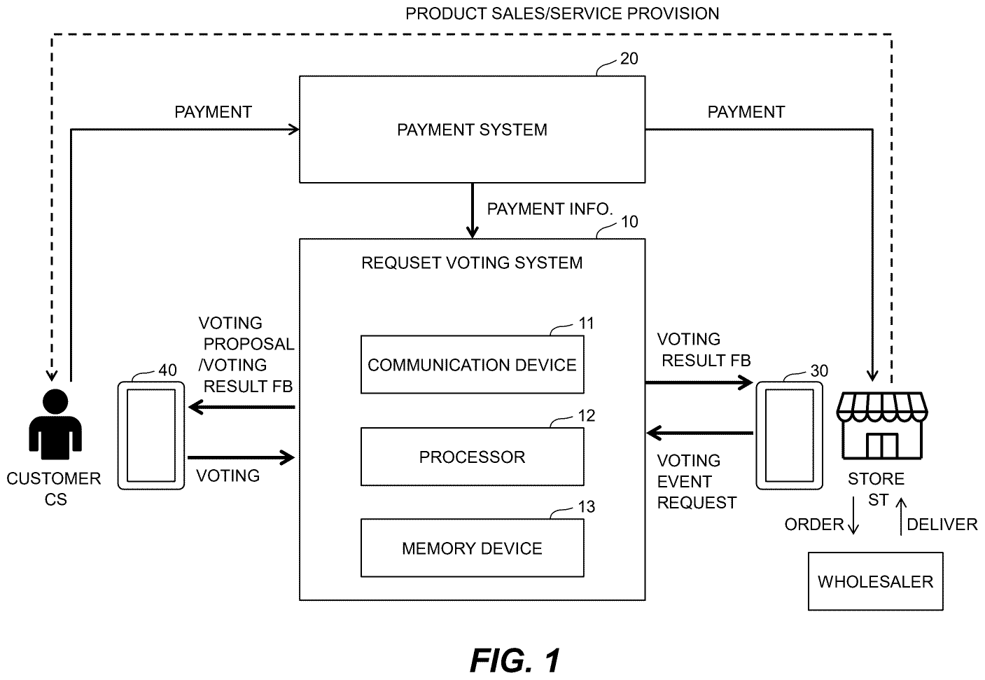

FIG. 1 is a diagram illustrating a configuration example of a commercial activity support system according to an embodiment of the present disclosure (hereinafter also simply referred to as a “system”). FIG. 1 depicts a request voting system 10, a payment system 20, a store management terminal 30, and a voting reception terminal 40. These elements constitute the system according to the embodiment.

The system according to the embodiment provides a support for commercial activity that benefit both a store ST and a customer CS. The store ST is a tenant store that, for example, conducts business by renting a certain section of a facility (e.g., grocery stores, daily goods stores, restaurants). Examples of the facility include commercial facilities (e.g., shopping malls, commercial buildings). The customer CS is a consumer of products sold by the store ST and services provided by the store ST. For example, the customer CS is a resident of an urban area or city where the store ST is located.

The request voting system 10 provides a service (hereinafter, also referred to as a “request voting service”) that is responsible for collecting needs of the customer CS from a request voting by the customer CS as a starting point, and guiding the customer CS to visit the store ST, purchase the product and/or use the service at the store ST. A voting target in the request voting includes multiple candidates for at least one of a new product that store ST is considering selling, and a new service that store ST is considering offering.

The request voting system 10 includes a communication device 11, one or more processors 12 (hereafter, simply referred to as a “processor 12”), and one or more memory devices 13 (hereafter, simply referred to as a “memory device 13”). The communication device 11 communicates with each of the payment system 20, the store management terminal 30, and the voting reception terminal 40 via a wired or wireless communication network.

The processor 12 executes various processing. Examples of the processor 12 include a general-purpose processor, a purpose-specific processor, a CPU (Central Processing Unit), a GPU (Graphics Processing Unit), an ASIC (Application Specific Integrated Circuit), and an FPGA (Field-Programmable Gate Array). The memory device 13 stores various information necessary for various processing. Examples of the memory device 13 include volatile memory, non-volatile memory, an HDD (Hard Disk Drive), and an SSD (Solid State Drive), among others.

The processor 12 may execute a computer program. The computer program, for example, is stored in the memory device 13. The computer program may also be recorded on a computer-readable recording medium. Through the cooperation of the processor 12 executing the computer program and the memory device 13, function of the request voting system 10 can be implemented.

The payment system 20 provides a service (a payment service) for settling at least one of the products sold at the store ST and the services provided at the store ST. The basic configuration of the payment system 20 is the same as that of the request voting system 10. Namely, the payment system 20 includes a communication device, one or more processors (hereafter simply referred to as a “processor”), and one or more memory devices (hereafter simply referred to as a “memory device”).

In the memory device of the payment system 20, there is a database storing various information related to the payment service (such as, transaction data for products or services, master data for products). The processor of the payment system 20 executes processing related to the payment of at least one of the products and the services by the customer CS. In the processing related to payment, for example, authentication of the customer CS (e.g., facial authentication) is conducted using a camera installed at the store ST. Once the authentication is completed, the processor accepts a payment operation from the customer CS via the voting reception terminal 40's payment function. When the payment is completed, the processor sends a payment result of the customer CS to the store ST (e.g., the voting reception terminal 40). Moreover, the processor sends the payment information to the request voting system 10. The payment information includes details such as the information of customer CS who made the payment, the content, quantity, and amount of the product or service the customer CS paid for.

The store management terminal 30 is an information terminal that manages at least one of the products sold by the store ST and the services provided by the store ST. The basic configuration of the store management terminal 30 is the same as that of the request voting system 10. The store management terminal 30 manages product orders to wholesalers and the receipt of products as part of the management of products sold by the store ST. As part of managing the services provided by store ST, the store management terminal 30 handles the arrangement of business supplies necessary for service activity and the placement of employees. The store management terminal 30 sends and receives various information regarding the request voting service with the request voting system 10.

The voting reception terminal 40 is an information terminal operated by the customer CS. The basic configuration of the voting reception terminal 40 is the same as that of the request voting system 10. Examples of the voting reception terminal 40 include an information terminal of the store ST for processing the payment for at least one of the products and the services at the store ST (e.g., an in-store tablet), as well as an information terminal used by the customer CS for the payment (e.g., a smartphone). The voting reception terminal 40 sends and receives various information related to the request voting service with the request voting system 10.

2. Request voting

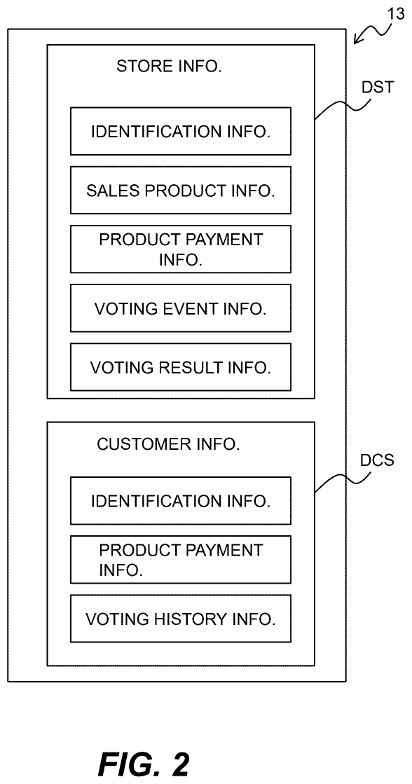

The various processing executed by the processor 12 include processing related to a request voting (hereinafter also referred to as “request voting processing”). The memory device 13 stores various information used for the request voting processing. FIG. 2 is a diagram illustrating an example of the various information used for the request voting processing. In the example shown in FIG. 2, the various information includes store information DST and customer information DCS. When there are multiple stores ST using the request voting service, the store information DST and customer information DCS are managed for each store ST using the request voting service.

In the example shown in FIG. 2, the store information DST includes identification information, sales product information, product payment information, voting event information, and voting result information on the store ST using the request voting service. In the explanation of FIG. 2, it is based on the premise that store ST sells products, but by substituting each occurrence of “sales” with “provision,” “product” with “service,” “purchase” with “utilization,” and “incoming stock” with “introduction,” an example of when the store ST provides services is explained.

The identification information includes, for example, ID number of the store ST and attributes of the store ST (such as business form and business scale). The sales product information includes, for example, ID number of a product currently on sale at the store ST and attributes of this product. The sales product information is obtained from the information terminal of the store ST (e.g., the store management terminal 30). The attributes of the product are set by appropriately combining elements that constitute the product's master data (e.g., category, size, weight, color, target market, release date, etc.). The product payment information is generated based on payment information from payment system 20. The payment information of the product includes, for example, the ID number of the sold product, the date and time of the product sale, the number of units sold, the sale price, and the ID number of the purchaser.

The voting event information pertains to information related to an organization of the request voting. The voting event information includes ID number of the request voting, voting theme (e.g., “Sweets that evoke spring”), and a voting reception period (such as starting and ending dates and times), as well as information about the voting targets (e.g., ID number, planned sales price, product images, introductory text, etc.). The voting event information is obtained from the information terminal of the store ST (e.g., the store management terminal 30). The voting result information pertains to information related to results of the request voting. The voting result information includes, for example, the ID number of the request voting, the voting theme, the voting reception period, and the information on the voting targets (such as voting rank, voting count, voting rate, etc.).

Here, the voting targets included in the voting event information includes products currently sold by the store ST (existing products), as well as a product that the store ST is considering for stock and sale in a near future (e.g., next month) (a new product). Examples of the new product include a product newly produced by a manufacturer, or a product that is already being sold in the market but has no sales record at the store ST. The new product also includes an improved product released after modifying an existing product. Even if the store ST was selling the existing product, when an improved product is released, that improved product is regarded as the new product. Furthermore, the existing product and the improved product can be distinguished by referring to the product's master data (the release date), for example.

In the example shown in FIG. 2, the customer information DCS also includes identification information, product payment information, and voting history information of the customer CS.

The identification information includes ID number of the customer CS and attributes of the customer CS (such as gender, age, and family structure), as well as preferences of the customer CS (such as purchasing preferences, voting preferences, etc.). The identification information may also include identification information on the information terminal of the customer CS and face image information necessary for authentication of the customer CS. The product payment information includes ID number of the product purchased by the customer CS at the store ST, purchase date and time of the product, quantity of the purchased product, purchase price information, and so on. The voting history information pertains to history information when the customer CS voted in response to the request voting proposal by the store ST. Examples of the voting history information include ID number of the request voting, voting targets for which the customer CS voted, voting date and time, the total number of votes for the voting targets, and so on.

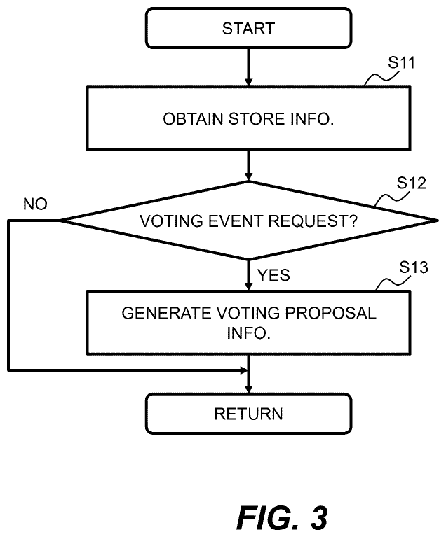

A flow of the request voting processing will be explained with reference to FIGS. 3 to 7. Note that in the description of FIGS. 3 to 7, the voting targets is based on a product, but by applying a substitution example in FIG. 2 to FIGS. 3 to 7, it offers an example when the voting targets is a service. FIGS. 3, 4, 6, and 7 are flowcharts showing examples of the request voting processing conducted by the request voting system 10 (the processor 12).

The processing routine shown in FIG. 3 is executed repeatedly in a preset cycle (e.g., daily, weekly, monthly). In the processing routine shown in FIG. 3, first, the store information DST is acquired (step S11). As for the configuration example of the store information DST, it is referenced and explained in FIG. 2.

Following the processing in step S11, it is determined whether there is a voting event request (step S12). For example, if the store information DST (the voting event information) obtained in step S11 has been updated, it is determined that there is the voting event request. In the processing of step S12, it may be determined whether conditions for holding the event are met by referring to the voting event information. Examples of the conditions for holding the event include the setting of the voting theme, the setting of the voting reception period, the setting of multiple voting targets, the shared attributes of the voting targets, and the relation between the attributes of the voting targets and the voting theme. If it is determined that the event conditions are not met, assist information may be sent to the information terminal of store ST, which is the source of store information DST (e.g., the store management terminal 30), prompting the registration of necessary information to satisfy the conditions.

If the judgment result of step S12 is negative, the current process will end. If the judgment result of step S12 is positive, voting proposal information is generated (step S13). The voting proposal information is information that proposes to the customer CS of the source store ST of store information DST to proceed with the request voting on the voting targets. The voting proposal information is generated based on the voting event information obtained in step S11. The voting proposal information is generated, for example, by allocating multiple voting targets for each ID number of the request voting or voting theme.

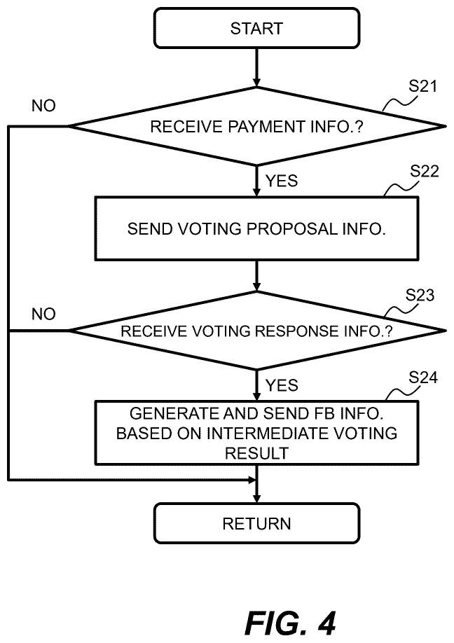

The processing routine shown in FIG. 4 is repeatedly executed with a predetermined cycle during the voting reception period of the request voting. In the processing routine shown in FIG. 4, it is first determined whether the payment information has been received (step S21). As previously explained, the payment information is sent from the payment system 20 to the request voting system 10 when the customer CS makes the payment for at least one of the products and services in the store ST.

If the judgement result of step S21 is negative, the current processing will end. If the judgement result of step S21 is positive, the voting proposal information is transmitted (step S22). The destination for sending the proposal voting information is the voting reception terminal 40 used for the payment of at least one of the products or services by the customer CS. The voting reception terminal 40 is the information terminal of the store ST (such as an in-store tablet) or the information terminal of the customer CS (such as a smartphone).

Following the processing of step S22, it is determined whether voting response information has been received (step S23). The voting response information is information entered into the voting reception terminal 40 by the customer CS as a response to the voting proposal information output from the voting reception terminal 40. Whether the voting response information has been received is judged based, for example, on whether the voting response information was received before an elapsed time, starting from a transmission of the voting proposal information, reaches a predetermined time period.

If the judgement result of step S23 is negative, this process will end. If the judgement result of step S23 is positive, feedback information based on the interim voting result is generated and sent (step S24). The interim voting result is real-time information generated based on voting result information where response information received during the acceptance period is sequentially reflected. The feedback information generated in step S24 is intended for the customer CS who participated in the vote in response to the voting proposal. Examples of the feedback information include various intermediate voting counts for multiple voting targets. By feeding back such the intermediate information to the customer CS, it is possible to know the preferences of other customers CS. Additionally, it is also possible to give the customer CS a sense of satisfaction by cooperating in the operation of the store ST.

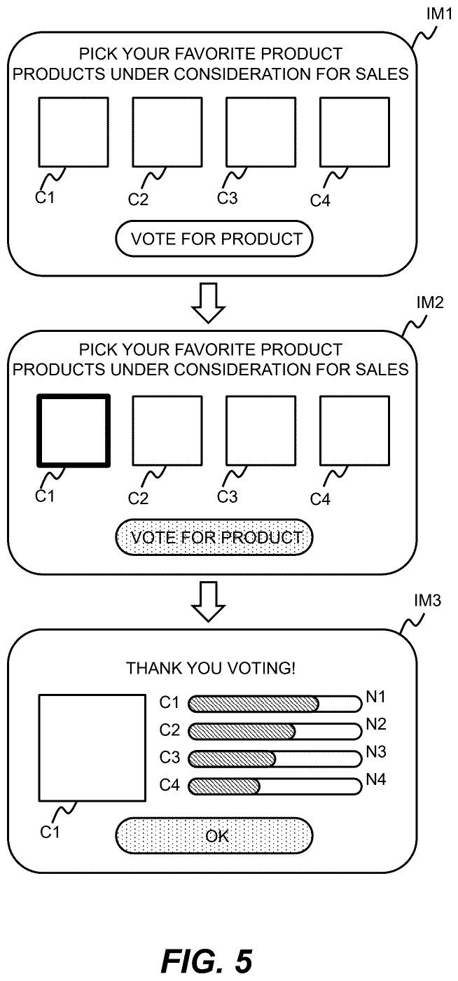

FIG. 5 is a diagram showing an example of the information output from the voting reception terminal 40 during the processing steps S21 to S24. In the upper section of FIG. 5, a voting image IM1, which is generated based on the voting proposal information, is depicted. A voting image IM1 contains images of products C1, C2, C3, and C4 as the voting targets. Additionally, the voting image IM1 contains text images with messages such as “Pick your favorite product” and “Products under consideration for sale,” along with an icon image labeled “Vote for this product.”

In the middle section of FIG. 5, a voting image IM2 is depicted, which is generated when the customer CS taps the location of the product C1 image within the voting image IM1 to select the product C1. In the voting image IM2, an emphasis, such as surrounding the frame of the product C1 image with a thick border, is added. In the voting image IM2, there is also emphasis by changing the color of the icon image that says “Vote for this product.”

In the lower section of FIG. 5, a voting image IM3 is depicted, which is output from the voting reception terminal 40 when the customer CS taps on the location of the icon image within the voting image IM2. The voting image IM3 includes an image of the voting targets (the product C1) for which the customer CS voted. Additionally, the voting image IM3 contains an image of a horizontal bar graph depicting intermediate voting counts N1, N2, N3, and N4 for the voting targets. Additionally, the voting image IM3 contains a text image showing gratitude to the customer CS (Thank you for voting!).

The feedback information generated in step S24 may also include a sales forecast at the store ST, which is the voting targets where the customer CS voted. The sales forecast can be calculated based on conditions such as when store ST is likely to start selling the voting targets (e.g., being the product with the highest vote ranking, the product with the highest voting percentage, or the product with a number of votes above a certain standard), and the interim voting result of the voting targets. The sales forecast may be output solely from the voting reception terminal 40, or in combination with the intermediate voting numbers of multiple voting targets as appropriate. By feeding back sales prospects to the customer CS, it is possible to provide information to the customer CS about the possibility of being able to purchase the voting targets for which the customer voted in the store ST in the near future.

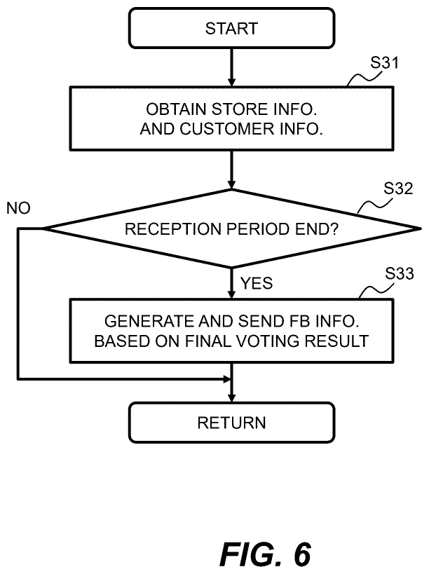

The processing routine shown in FIG. 6 is repeatedly executed in a predetermined cycle (e.g., daily, weekly, monthly). In the processing routine shown in FIG. 6, first, the store information DST and the customer information DCS are acquired (step S31). The explanation regarding the configuration example for the store information DST and the customer information DCS is as described in FIG. 2.

Following the processing in step S31, it is determined whether the voting reception period has ended (step S32). Whether the voting reception period has ended is determined based on the voting event information or voting result information (voting reception period).

If the judgement result in step S32 is negative, the current process will end. If the judgement result of step S32 is positive, the generation and transmission of feedback information (FB information) based on the final voting result will be conducted (step S33). The final voting result is the final information that reflects all response information during the acceptance period. The feedback information generated in step S34 includes information for the customer CS who responded (voted) according to the voting proposal, and information for the store ST, the originator of the voting event.

As feedback information aimed at the customer CS, the final voting count for each of the multiple voting targets is exemplified. By providing such the final information as feedback to the customer CS, it is possible to inform the customer CS about the potential availability of the voting targets for which the customer CS voted at store ST in the near future. Furthermore, although the customer CS did not vote, it is possible to provide the customer CS with information on the possibility that the voting targets selected by the request voting will be available for purchase at the store ST in the near future. The transmission of feedback information to the customer CS can be conducted by identifying the information terminal used as the voting reception terminal 40 for the customer CS based on the customer information DCS (the identification information).

The feedback information directed at store ST includes the final voting count for each voting target, the estimated sales amount from the sale of each voting target, and the attributes of the customer CS who voted for each voting target. The estimated sales amount from the sale of the voting targets can be calculated using a prediction model (statistical model) based on machine learning, for example. The attributes of the customer CS who voted for voting targets can be generated based on the customer information (the voting history information), for example. By feeding back the estimated sales amount to store ST, it becomes possible to provide the store ST with the information needed to make a final decision on the sales of the voting targets. By feeding back customer attributes to the store ST, it is possible to provide materials needed to select the voting targets for future request voting to the store ST.

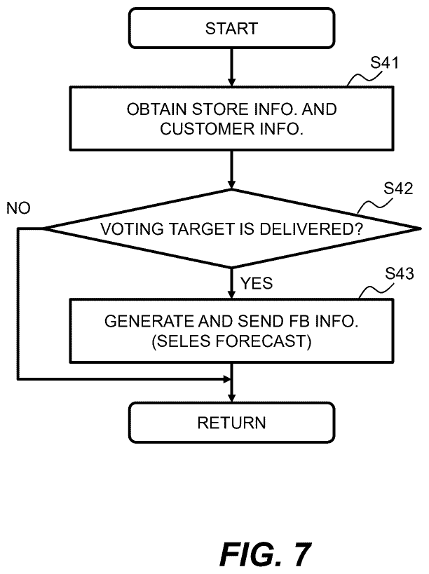

The processing routine shown in FIG. 7 is executed repeatedly on a predetermined cycle (e.g., daily, weekly, monthly). In the processing routine shown in FIG. 7, first, the store information DST and the customer information DCS are obtained (step S41). The processing in step S41 is the same as the processing in step S31 of FIG. 6.

Following the processing in step S41, it is determined whether the voting targets has been delivered to the store ST (step S42). Whether the voting targets has been stocked in store ST is determined by, for example, matching the ID numbers of the voting targets included in the voting event information with the product ID numbers included in the sales product information. If the final decision on the sale of the voting targets is included in the voting event information on the store information DST, the determination in step S42 may be based on this final decision.

If the judgement result of step S42 is negative, the current process will end. If the judgement result of step S42 is positive, the generation and transmission of feedback information (sales forecast) is carried out (step S43). The sales forecast includes information such as the planned in-store sales date, planned sales volume, and planned sales price of the voting targets voted on by the customer CS. The sales forecast may also include information such as the planned in-store sales date, planned sales volume, and planned sales price of voting targets not voted on by the customer CS. By providing feedback on such sales plans to the customer CS, it is possible to inspire the desire to visit the store ST and purchase from the voting targets in the customer CS.

### 3. Effect

As explained above, according to the embodiment, the request voting processing is carried out. According to the request voting processing, it is possible to collect voting result information on multiple candidates, designated as the voting targets, concerning at least one of the new product the store ST is considering selling and the new service the store ST is considering offering. Therefore, it is possible to grasp customer needs for the new product and the new service.

Additionally, the feedback information on various types can be generated based on the voting result information and sent to the customer CS and the store ST. Accordingly, by the request voting, it is also possible to support the commercial activity beneficial to both the store ST and the customer CS.

What is claimed is:

1. A commercial activity support system for supporting a commercial activity of a store that performs at least one of product sales and service provision, comprising:
one or more memory devices are configured to store store information related to the store; and
one or more processors are configured to execute various processing,
wherein the store information includes information on at least one of a new product that the store is considering selling and information on a new service that the store is considering providing,
wherein one or more processors are configured to execute processing to:
generate voting proposal information for making multiple candidates for at least one of the new product and the new service with respect to voting targets for request voting by customers of the store, based on information on at least one of the new product and the new service, and send this information to a voting reception terminal; and
receive voting response information from the voting reception terminal in response to the voting proposal information.

2. The system according to claim 1,
wherein the one or more processors further configured to execute processing to:
generate feedback information for the store based on a final voting result of the request voting generated from the voting response information; and
send the feedback information for the store to an information terminal of the store,
wherein the feedback information for the store includes each final voting count for the voting targets, an estimated sales amount from at least one of sales and provision of the voting targets, and at least one of the customer attributes who voted for the voting targets.

3. The system according to claim 1,
wherein the one or more processors further configured to execute processing to:
generate feedback information for the customer based on an interim voting result on the request voting generated from the voting response information; and
send the feedback information for the customer to the voting reception terminal,
wherein the feedback information for the customer includes at least one of an intermediate voting count for each voting target and a prospect of at least one of sales and provision of the respective voting targets at the store.

4. The system according to claim 1,
wherein the one or more processors further configured to execute processing to:
generate feedback information for the customer based on the final voting result of the request voting generated from the voting response information; and
send the feedback information for the customer to the voting reception terminal,
wherein the feedback information for the customer includes at least one of the final voting count for each voting target and a plan of at least one of sale and provision of the respective voting targets at the store.

5. The system according to claim 1, wherein:
the new product includes a product with no sales record at the store;
the new service includes a service with no provision record at the store; and
the voting reception terminal includes an information terminal operated by the customer at a payment of at least one of the product and service at the store.
